(19) United States
(12) Patent Application Publication
(10) Pub. No.: US 2006/0048591 A1
(43) Pub. Date: Mar. 9, 2006

(54) Mechanism for converting reciprocating movement into unidectional rotary movement

(76) Inventor: Edward Veremkroit, Peabody, MA (US)

Correspondence Address: Edward Veremkroit, 71 Edgewood Way, Apt. 22, Peabody, MA, 01560, US

(21) Appl. No.: 11/188,085

(22) Filed: Jul. 25, 2005

Related U.S. Application Data
(60) Provisional application No. 60/607,503, filed on Sep. 7, 2004.

(51) Int. Cl. F16H 25/00

(52) U.S. Cl. 74/88

(57) ABSTRACT

A mechanism for converting reciprocating movement into unidirectional rotary movement comprises: a rotating shaft that has at least two incompatible helical grooves turned in opposite directions. The shaft is placed inside a feed clutch that can reciprocate along the shaft. The feed clutch has a housing on each end and sliding rings are placed inside the housings. The sliding rings have balls that extend into the helical grooves. The sliding rings are supported by clutch bearings that are installed for rotation in opposite directions. When the feed clutch reciprocates the balls sliding along the helical grooves make the shaft rotate unidirectional.

| | |
|---|---|
| Current U.S. Class: | 74/89, 44 |
| Internal Class: | F16H 025/24 |
| Field of Search | 74/89, 44; 74/124.125; 74/424.95; 475/281; |
| | 123/197.1 |

References Cited
U.S. Patent Documents

| | | | |
|---|---|---|---|
| 4,811,618 | Mar 14, 1989 | Takayama | 74/89, 44 |
| 5,551,314 | Sept 3, 1996 | Andrzewski | 74/424, 77 |
| 5,913,941 | Jun. 22, 1999 | Erickson | 74/424.95 |
| 6,779,415 | Aug 24, 2004 | Gogins | 74/124.125 |
| 5,673,665 | Oct 7, 1997 | Kim | 123/197.1 |
| 6,835,158 | Dec 28, 2004 | Suigiura | 475/281, 280 |

Nill Scalter, Nicholas Chronis “Mechanisms & mechanical devices sourcebook”

### STATEMENT REGARDING FEDERALLY SPONSERED RESERCH OR DEVELOPMENT

Not Appliable

### REFERENCE TO SEQUENCE LISTING, A TABLE, OR COMPUTER PROGRAM LISTING COMPAKT DISK APPENDIIX

Not applicable

### TECHNICAL FIELD

The present invention relates to mechanical transmissions for converting reciprocating movement into rotary movement. These kinds of transmissions can be use in power engineering, tooling, sport devices, toys and other fields of technology and industry.

### BACKGROUND OF THE INVENTION

The crank mechanism for converting reciprocating movement into rotary movement is known for use in piston engines. The rotation of the shaft in this mechanism is transmitted from the moving reciprocal-translation piston rod by means of pressure on the arm of the crankshaft.

The basic disadvantage of this mechanism is that the motion of the piston rod provides only a part of the phase of rotation and so-called “dead points” are formed, which need to be overcome by a heavy flywheel or several similar pistons set up on one shaft and other devices, because it is necessary to regulate their interaction. All these make a structure of high cost mechanical complexity that is heavy and needs a lot of space.

Also, ball-bearing screw mechanisms are known. For example, Flenor Reversing Actuator produced by a Division of Norco, Inc.

The basic disadvantage of these mechanisms is the fact that they cannot be used to create rotary motion that is continuous and uninterrupted, let alone unidirectional.

The goal of this invention is to create a mechanism for converting reciprocating motion into uninterrupted unidirectional rotary that is free of these disadvantages indicated in the art.

### BRIEF SUMMARY OF THE INVENTION

The object of the present invention is therefore to provide conversion of reciprocal motion into uninterrupted unidirectional rotary movement eliminating no-motion dead points.

Another fundamental object of the invention is to make the mechanism lighter and make more compact.

This mechanism permits adjustment of rotational speed by changing the angle of the helical groves.

### BRIEF DESCRIPTION OF THE SEVERAL VIEWS OF THE DRAFTING

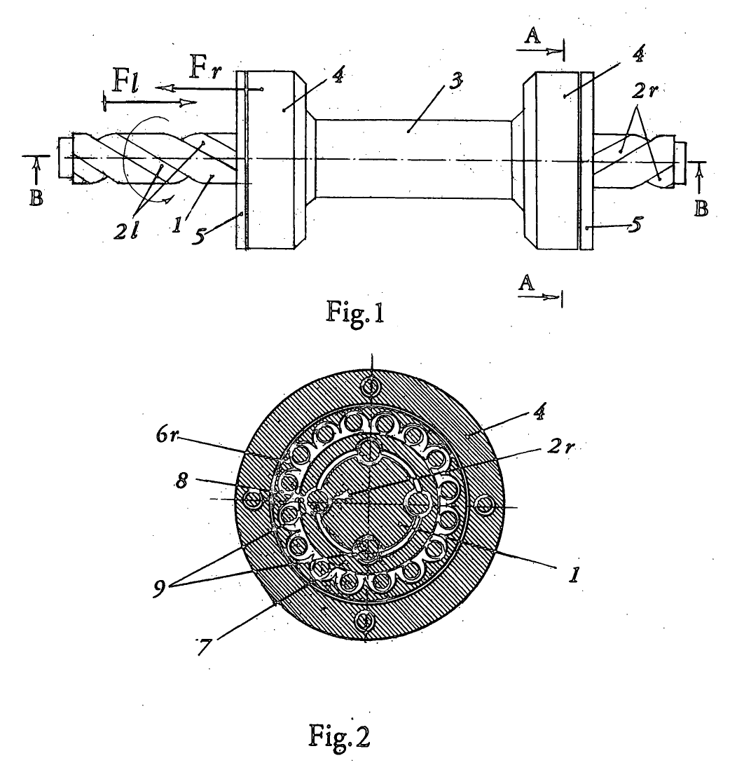

FIG. 1 shows the side view of the Mechanism.

FIG. 2 shows the cross section of the Mechanism

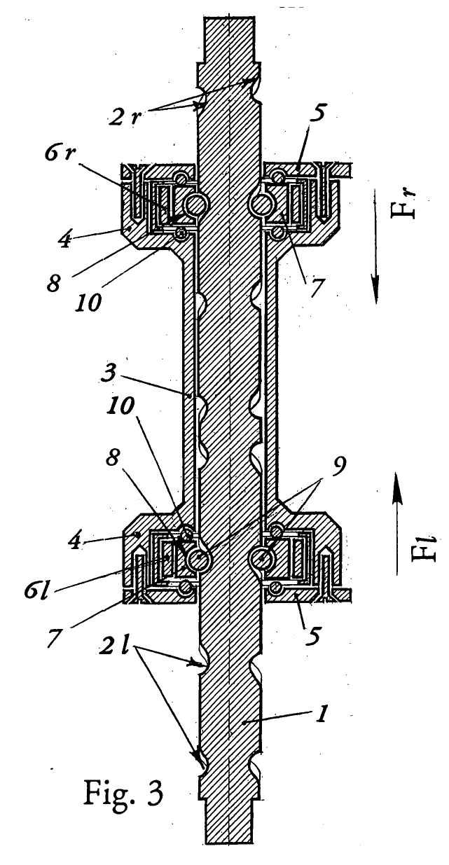

FIG. 3 shows the longitudinal section of the Mechanism

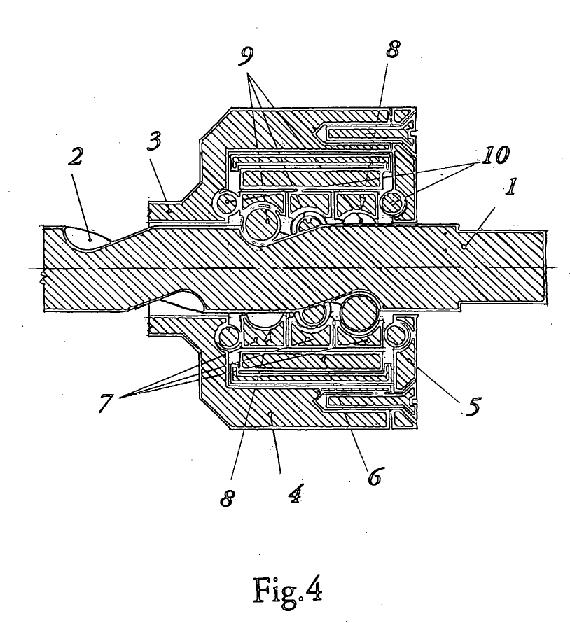

FIG. 4 shows the fragment of the longitudinal section of the variant of the Mechanism with few sliding rings.

### DETAILED DESCRIPTION OF THE INVENTION

Referring to FIG. 1, FIG. 2, FIG. 3, and FIG. 4

The present invention comprises:

a rotating shaft 1 that has at least two opposite-hand helical grooves 2l and 2r located on opposite ends, and a feed clutch 3. The feed clutch 3 comprises: two housings 4 on its opposite ends, two caps 5, clutch bearings 6l and 6r are fixed inside the housings 4 that are installed for rotation in opposite directions, sliding rings 7 that are supported by the clutch bearings 6l and 6r that have some numbers of the equal distributed mortises 8 on the their inner sides, the balls 9 half of which are located inside the mortises 8 and half of which are located in the helical grooves 2l and 2r of the rotating shaft 1, the sliding ring 7 supported by the thrust bearings 10 on its sides.

The mechanism works in the following way:

When the feed clutch 3 under the effect of force F-l makes a limited translating motion along the rotating shaft 1, for example, from right to left, then the sliding ring 7 in the right housing 4 is retained by the clutch bearing 6r and can't rotate, balls 9 that are fixed on this sliding ring are sliding along the helical grooves 2r force the rotating shaft 1 to rotate clockwise. At the same time the sliding ring 7 in left housing 4 that isn't retained by the clutch bearing 6l is rotating by the rotating shaft 1 space in same direction. When the feed clutch 3 under the effect of force F-r makes translating motion from left to right, the sliding ring 7 located in the right housing 4 is retained, and forces the shaft 1 to rotate. However, because helical grooves 2l on the left side of the shaft 1 have opposite directions of rotation, the direction of rotation of the shaft 1 does not change.

In cases when the surface area of interactive parts needs to increase a few sliding rings 7 can be fixed inside the widened housings 4, as shown in FIG. 4.

I claim:

1. A mechanism for converting reciprocating movement into unidirectional rotary movement comprising:
a rotating shaft that has at least two incompatible helical grooves turned in opposite directions.

2. A mechanism for converting reciprocating movement into unidirectional rotary movement of claim 1 comprising:
a feed clutch which can reciprocate along a shaft
or a shaft can reciprocate inside the feed clutch

3. A mechanism for converting reciprocating movement into unidirectional rotary movement of claim 1 comprising:
two housings on the opposite ends of the feed clutch.

4. A mechanism for converting reciprocating movement into unidirectional rotary movement of claim 1 comprising
two caps which close the housings

5. A mechanism for converting reciprocating movement into unidirectional rotary movement of claim 1 comprising:
at least two clutch bearings that are fixed into the housings.

6. A mechanism for converting reciprocating movement into unidirectional rotary movement of claim 1 comprising
at least two sliding rings supported by clutch bearings

7. A mechanism for converting reciprocating movement into unidirectional rotary movement of claim 1 comprising:
some number of equally spaced mortises located on inner side of every sliding ring

8. A mechanism for converting reciprocating movement into unidirectional rotary movement of claim 1 comprising
some number balls
the balls are held by the sliding ring mortises and extend into the helical grooves of the rotating shaft

9. A mechanism for converting reciprocating movement into unidirectional rotary movement of claim 1 comprising
at least two thrust bearings fixed into every housing which support the sliding rings
